(19) United States
(12) Patent Application Publication
(10) Pub. No.: US 2025/0220592 A1
(43) Pub. Date: Jul. 3, 2025

(54) APPARATUSES AND METHODS FOR TRANSMISSION QUALITY AWARE UPLINK POWER CONTROL

(71) Applicant: Nokia Technologies Oy, Espoo (FI)

(72) Inventors: Oskari TERVO, Oulu (FI); Esa Tapani TIIROLA, Oulu (FI)

(21) Appl. No.: 18/850,880

(22) PCT Filed: Apr. 5, 2022
(86) PCT No.: PCT/EP2022/058912

§ 371 Date: Sep. 25, 2024

(51) Int. Cl. H04W 52/26; H04W 52/14; H04W 52/36

(52) U.S. Cl. CPC H04W 52/265; H04W 52/146; H04W 52/367

(57) ABSTRACT

An apparatus includes at least one processor; and at least one memory including computer program code; wherein the at least one memory and the computer program code are configured to, with the at least one processor, cause the apparatus at least to: determine a transmission power requested with a network node; determine a transmission quality class based on the transmission power requested with the network node; wherein the transmission quality class comprises a predefined maximum power reduction; determine an output power value based on the transmission quality class; determine an uplink transmission power as a minimum of: the output power value, and the transmission power requested with the network node; and transmit an uplink transmission, based on the uplink transmission power.

### TECHNICAL FIELD

The examples and non-limiting example embodiments relate generally to communications and, more particularly, to TX quality aware uplink power control.

### BACKGROUND

It is known to manage energy consumption of devices in a communication network.

### SUMMARY

In accordance with an aspect, an apparatus includes at least one processor; and at least one memory including computer program code; wherein the at least one memory and the computer program code are configured to, with the at least one processor, cause the apparatus at least to: determine a transmission power requested with a network node; determine a transmission quality class based on the transmission power requested with the network node; wherein the transmission quality class comprises a predefined maximum power reduction; determine an output power value based on the transmission quality class; determine an uplink transmission power as a minimum of: the output power value, and the transmission power requested with the network node; and transmit an uplink transmission, based on the uplink transmission power.

In accordance with an aspect, an apparatus includes at least one processor; and at least one memory including computer program code; wherein the at least one memory and the computer program code are configured to, with the at least one processor, cause the apparatus at least to: request, with a network node, a transmission power for a user equipment; transmit an uplink grant to a user equipment, the uplink grant comprising at least one parameter configured to be used to determine the transmission power requested with the network node for the user equipment; wherein a transmission quality class is determined based on the transmission power requested with the network node for the user equipment; wherein the transmission quality class comprises a predefined maximum power reduction; wherein an output power value is determined based on the transmission quality class; wherein an uplink transmission power is determined as a minimum of: the output power value, and the transmission power requested with the network node for the user equipment; and receive an uplink transmission, based on the uplink transmission power.

In accordance with an aspect, an apparatus includes at least one processor; and at least one memory including computer program code; wherein the at least one memory and the computer program code are configured to, with the at least one processor, cause the apparatus at least to: receive an uplink grant from a network node, the uplink grant comprising at least one parameter configured to be used to determine a transmission power requested with the network node; determine the transmission power requested with the network node, based on the at least one parameter received with the uplink grant; wherein the uplink grant comprises information related to whether an uplink transmission regulatory framework comprises a legacy regulatory framework or a relaxed regulatory framework; determine a transmission quality class based on the transmission power requested with the network node, in response to the uplink transmission regulatory framework comprising the relaxed regulatory framework; wherein the transmission quality class comprises a predefined maximum power reduction; determine an output power value based on the transmission quality class, in response to the uplink transmission regulatory framework comprising the relaxed regulatory framework; determine an uplink transmission power as a minimum of: the output power value, and the transmission power requested with the network node; and transmit an uplink transmission, based on the uplink transmission power.

In accordance with an aspect, a method includes determining a transmission power requested with a network node; determining a transmission quality class based on the transmission power requested with the network node; wherein the transmission quality class comprises a predefined maximum power reduction; determining an output power value based on the transmission quality class; determining an uplink transmission power as a minimum of: the output power value, and the transmission power requested with the network node; and transmitting an uplink transmission, based on the uplink transmission power.

In accordance with an aspect, a method includes requesting, with a network node, a transmission power for a user equipment; transmitting an uplink grant to a user equipment, the uplink grant comprising at least one parameter configured to be used to determine the transmission power requested with the network node for the user equipment; wherein a transmission quality class is determined based on the transmission power requested with the network node for the user equipment; wherein the transmission quality class comprises a predefined maximum power reduction; wherein an output power value is determined based on the transmission quality class; wherein an uplink transmission power is determined as a minimum of: the output power value, and the transmission power requested with the network node for the user equipment; and receiving an uplink transmission, based on the uplink transmission power.

In accordance with an aspect, a method includes receiving an uplink grant from a network node, the uplink grant comprising at least one parameter configured to be used to determine a transmission power requested with the network node; determining the transmission power requested with the network node, based on the at least one parameter received with the uplink grant; wherein the uplink grant comprises information related to whether an uplink transmission regulatory framework comprises a legacy regulatory framework or a relaxed regulatory framework; determining a transmission quality class based on the transmission power requested with the network node, in response to the uplink transmission regulatory framework comprising the relaxed regulatory framework; wherein the transmission quality class comprises a predefined maximum power reduction; determining an output power value based on the transmission quality class, in response to the uplink transmission regulatory framework comprising the relaxed regulatory framework; determining an uplink transmission power as a minimum of: the output power value, and the transmission power requested with the network node; and transmitting an uplink transmission, based on the uplink transmission power.

In accordance with an aspect, an apparatus includes means for determining a transmission power requested with a network node; means for determining a transmission quality class based on the transmission power requested with the network node; wherein the transmission quality class comprises a predefined maximum power reduction; means for determining an output power value based on the transmission quality class; means for determining an uplink transmission power as a minimum of: the output power value, and the transmission power requested with the network node; and means for transmitting an uplink transmission, based on the uplink transmission power.

In accordance with an aspect, an apparatus includes means for requesting, with a network node, a transmission power for a user equipment; means for transmitting an uplink grant to a user equipment, the uplink grant comprising at least one parameter configured to be used to determine the transmission power requested with the network node for the user equipment; wherein a transmission quality class is determined based on the transmission power requested with the network node for the user equipment; wherein the transmission quality class comprises a predefined maximum power reduction; wherein an output power value is determined based on the transmission quality class; wherein an uplink transmission power is determined as a minimum of: the output power value, and the transmission power requested with the network node for the user equipment; and means for receiving an uplink transmission, based on the uplink transmission power.

In accordance with an aspect, an apparatus includes means for receiving an uplink grant from a network node, the uplink grant comprising at least one parameter configured to be used to determine a transmission power requested with the network node; means for determining the transmission power requested with the network node, based on the at least one parameter received with the uplink grant; wherein the uplink grant comprises information related to whether an uplink transmission regulatory framework comprises a legacy regulatory framework or a relaxed regulatory framework; means for determining a transmission quality class based on the transmission power requested with the network node, in response to the uplink transmission regulatory framework comprising the relaxed regulatory framework; wherein the transmission quality class comprises a predefined maximum power reduction; means for determining an output power value based on the transmission quality class, in response to the uplink transmission regulatory framework comprising the relaxed regulatory framework; means for determining an uplink transmission power as a minimum of: the output power value, and the transmission power requested with the network node; and means for transmitting an uplink transmission, based on the uplink transmission power.

In accordance with an aspect, a non-transitory program storage device readable by a machine, tangibly embodying a program of instructions executable with the machine for performing operations is described and provided, the operations comprising: determining a transmission power requested with a network node; determining a transmission quality class based on the transmission power requested with the network node; wherein the transmission quality class comprises a predefined maximum power reduction; determining an output power value based on the transmission quality class; determining an uplink transmission power as a minimum of: the output power value, and the transmission power requested with the network node; and transmitting an uplink transmission, based on the uplink transmission power.

In accordance with an aspect, a non-transitory program storage device readable by a machine, tangibly embodying a program of instructions executable with the machine for performing operations is described and provided, the operations comprising: requesting, with a network node, a transmission power for a user equipment; transmitting an uplink grant to a user equipment, the uplink grant comprising at least one parameter configured to be used to determine the transmission power requested with the network node for the user equipment; wherein a transmission quality class is determined based on the transmission power requested with the network node for the user equipment; wherein the transmission quality class comprises a predefined maximum power reduction; wherein an output power value is determined based on the transmission quality class; wherein an uplink transmission power is determined as a minimum of: the output power value, and the transmission power requested with the network node for the user equipment; and receiving an uplink transmission, based on the uplink transmission power.

In accordance with an aspect, a non-transitory program storage device readable by a machine, tangibly embodying a program of instructions executable with the for performing operations is described and provided, the operations comprising: receiving an uplink grant from a network node, the uplink grant comprising at least one parameter configured to be used to determine a transmission power requested with the network node; determining the transmission power requested with the network node, based on the at least one parameter received with the uplink grant; wherein the uplink grant comprises information related to whether an uplink transmission regulatory framework comprises a legacy regulatory framework or a relaxed regulatory framework; determining a transmission quality class based on the transmission power requested with the network node, in response to the uplink transmission regulatory framework comprising the relaxed regulatory framework; wherein the transmission quality class comprises a predefined maximum power reduction; determining an output power value based on the transmission quality class, in response to the uplink transmission regulatory framework comprising the relaxed regulatory framework; determining an uplink transmission power as a minimum of: the output power value, and the transmission power requested with the network node; and transmitting an uplink transmission, based on the uplink transmission power.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2A shows an example of improvement of the performance of an advanced hybrid deep learning receiver with respect to a traditional receiver (LMMSE) when non-linearities are present in the transmission, with a 16-QAM modulation scheme.

FIG. 2B shows an example of improvement of the performance of an advanced hybrid deep learning receiver with respect to a traditional receiver (LMMSE) when non-linearities are present in the transmission, with a 64-QAM modulation scheme.

FIG. 3 shows an example MPR for an FR1 scenario.

FIG. 4 shows an equation for PUSCH power control.

FIG. 5 is a graph illustrating that an increase of Tx power worsens Tx signal quality.

FIG. 6 shows a formula for Tx power requested by the gNB.

FIG. 7 shows a cell of a table that is related to a definition of new TX quality classes.

FIG. 8 is an example apparatus configured to implement the examples described herein.

FIG. 9 is an example method performed with a user equipment to implement the examples described herein.

FIG. 10 is an example method performed with an access node to implement the examples described herein.

FIG. 11 is an example method performed with a user equipment to implement the examples described herein.

### DETAILED DESCRIPTION OF EXAMPLE EMBODIMENTS

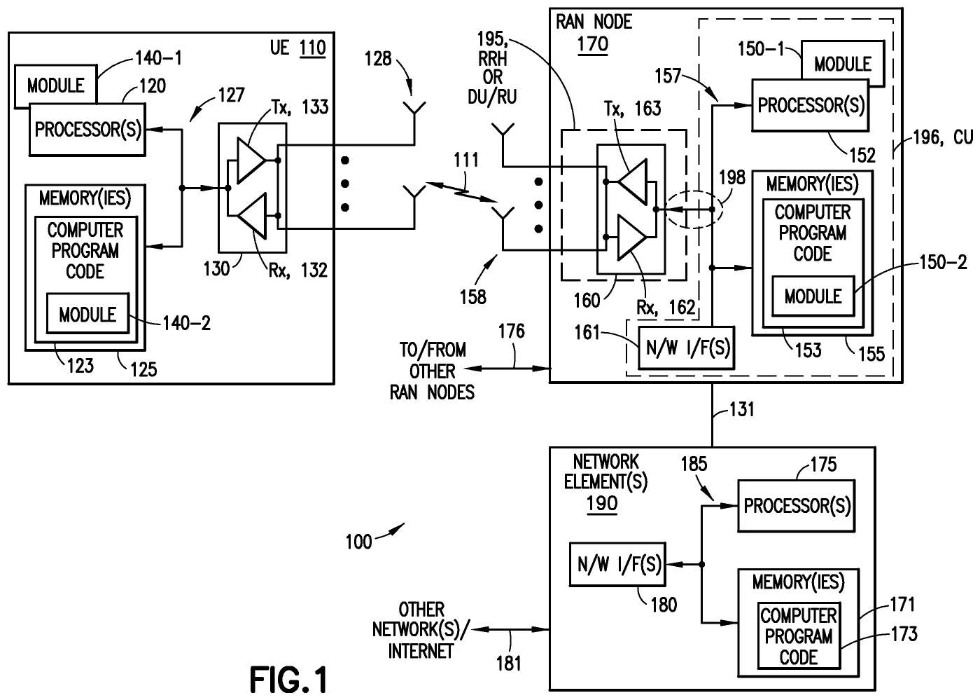

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A relay node in NR is called an integrated access and backhaul node. A mobile termination part of the IAB node facilitates the backhaul (a.k.a. parent link) connection. In other words, it's the functionality which carries UE functionalities. The distributed unit part of the IAB node facilitates the so called access link (a.k.a. child link) connections (i.e. for access link UEs, and backhaul for other IAB nodes, in the case of multi-hop IAB). In other words, it's responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network includes one or more processors 175, one or more memories 171, and one or more network interfaces (N/W I/F(s)) 180, interconnected through one or more buses 185. The one or more memories 171 include computer program code 173.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, purpose computers, special microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless capabilities, gaming devices having wireless communication communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions.

UE 110, RAN node 170, and/or network element(s) 190, (and associated memories, computer program code and modules) may be configured to implement (e.g. in part) the methods described herein, including TX quality aware uplink power control. Thus, computer program code 123, module 140-1, module 140-2, and other elements/features shown in FIG. 1 of UE 110 may implement user equipment related aspects of the methods described herein. Similarly, computer program code 153, module 150-1, module 150-2, and other elements/features shown in FIG. 1 of RAN node 170 may implement gNB/TRP related aspects of the methods described herein. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity.

The examples described herein are related to the field of power allocation in future systems. More specifically, a quality-aware power control design is described, when different types of BS receivers are able to compensate different levels of RF impairments of the UE transmitter, and thus enabling controlled higher EVM transmission from the UE. The main focus of the invention is for EVM limited modulations, such as 16-QAM or higher-order.

AI/ML is to be a part of the Rel-18 package. RAN #94 is discussing the exact scope of the AI/ML-related SI. The most recent SID draft is available at 3GPP TSG RAN Meeting #94e RP-213599 Electronic Meeting, Dec. 6-17, 2021 (revision of RP-212708). The most relevant part from the point of view of the examples described herein is the following objective:

“For the use cases under consideration:

[ . . . ]

2. Assess potential specification impact, specifically for the agreed use cases in the final representative set and for a common framework:
[ . . . ]
Interoperability and testability aspects, e.g., (RAN4)-RAN4 only starts the work after there is sufficient progress on use case study in RAN1 and RAN2.
   Requirements and testing frameworks to validate AI/ML based performance enhancements and ensuring that UE and gNB with AI/ML meet or exceed the existing minimum requirements if applicable.
   Consider the need and implications for AI/ML processing capabilities definition”

### UL Power Control:

UL power control in 5G systems is based on path loss so that it is calculated based on specific equation, which in general depends on the configured UEs maximum output power, received power target and path loss. UE transmit power for a PUSCH is determined by the following equation:

$${P}_{PUSCH , b , f , c} ( i , j , {q}_{d} , l ) = min \{ \begin{matrix}{P}_{CMAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

$$[ dBm ]$$

where the transmission power is capped by P_{CMAXf,c}(i), which is the UE configured maximum output power. UE can set the P_{CMAX,f,c} value in each slot, as long as the P_{CMAX,f,c} is set within the bounds:

P_{CMAX_L,f,c}≤P_{CMAX,f,c}≤P_{CMAX_H,f,c}, Where

P_{CMAX_L,f,c}=MIN{P_{EMAX,c}−ΔT_{C,c}, (P_{PowerClass}−ΔP_{PowerClass})−MAX(MAX MPR_{c}+ΔMPR_{c}, Δ-MPR_{c})+ΔT_{IB,c}+ΔT_{C,c}+ΔT_{RxSRS}, P-MPR_{c})} and P_{CMAX_H,f,c}=MIN{P_{EMAX,c},P_{PowerClass}−ΔP_{PowerClass}}. The terms are defined in TS38.101-1/38.101-2/38.101-3, while the exact definition of these terms is outside the scope of the examples described herein. However, it is essential to note that the gNB is not aware of the P_{CMAXf,c} (i) value that the UE uses, where the gNB knows only the boundaries within which P_{CMAXf,c} (i) is.

### Advanced Receivers Capable of Removing Non-Linear Distortion:

Advanced receivers have been shown to outperform traditional receivers under certain circumstances, especially with little or no DMRS, and with transmissions having severe nonlinear distortion. Non-linearities are caused mainly by RF components such as a power amplifier (PA) working in the non-linear region when pushed into saturation. The power efficiency is maximized, and higher transmitted power can be used for the signal but non-linear distortion deteriorates the quality of the transmitted signal.

In standard specifications, an upper bound in the transmitter passband degradation is imposed for instance by means of EVM (error vector magnitude) and IBE (in-band emissions) limits.

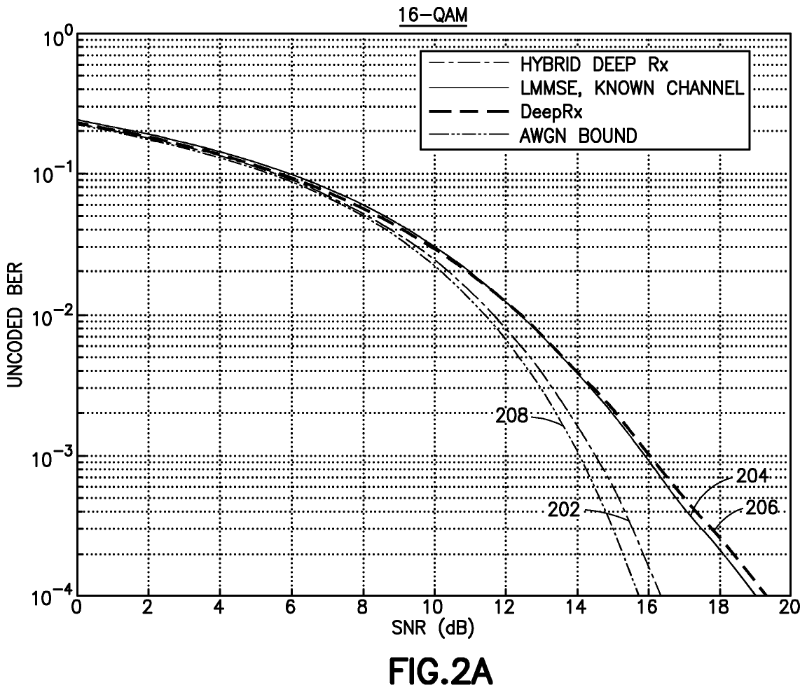

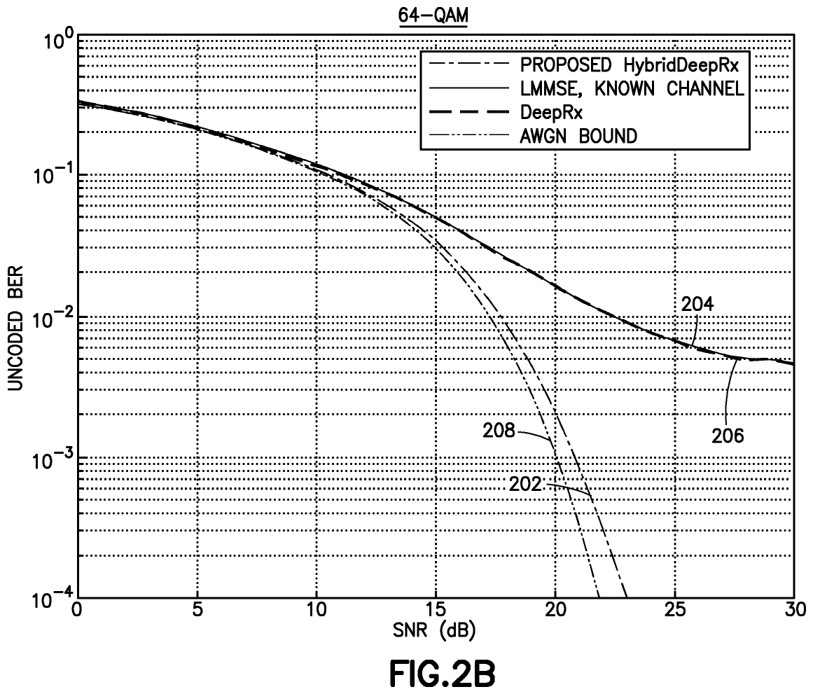

These upper bounds ensure a correct detection of the signal by a linear receiver. However, they also limit the output power due to imposing severe backoff (i.e. allowance for the maximum power reduction) for the transmitter PA and therefore reduce the achievable signal-to-noise ratio (SNR) at the receiver. It has been demonstrated that advanced receivers such as ML-based receivers (e.g. a deep learning receiver for high-EVM signals), can compensate the degradation caused by a PA driven into (or close to) saturation and perform several dB better than traditional linear receivers under reasonable levels of non-linear distortion. An example of the performance improvement is shown in FIG. 2A and FIG. 2B.

Particularly, FIG. 2A and FIG. 2B show an example of improvement of the performance of an advanced receiver, such as a hybrid deep learning Rx for high-EVM signals, with respect to a traditional receiver (LMMSE) when non-linearities are present in the transmission. FIG. 2A shows the uncoded BER performance of a hybrid deep receiver in comparison with a traditional receiver and benchmarks, under a PA backoff of 3 dB with a 16-QAM modulation scheme. FIG. 2B shows the uncoded BER performance of a hybrid deep receiver in comparison with a traditional receiver and benchmarks, under a PA backoff of 3 dB with a 64-QAM modulation scheme. In FIG. 2A and FIG. 2B, plot 202 corresponds to a hybrid deep learning receiver, plot 204 corresponds to LMMSE, known channel, plot 206 corresponds to DeepRx, and plot 208 corresponds to AWGN bound.

### Power Backoff/MPR:

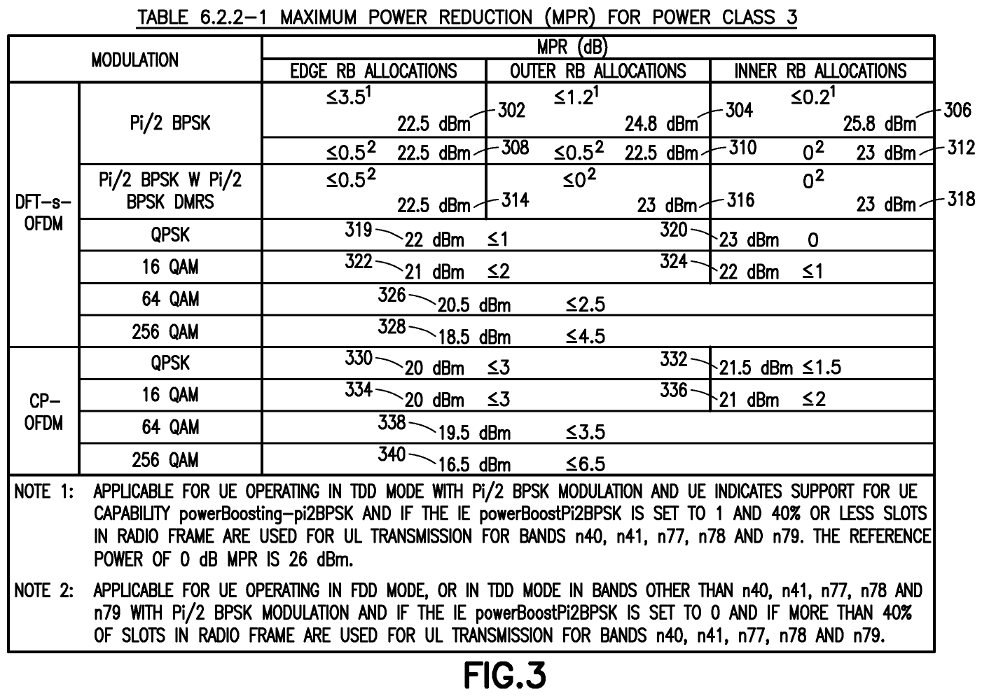

Power backoff in an amplifier is a power reduction below the saturation point of the amplifier to enable the amplifier to operate in the linear region even if there is a slight increase in the input power level. Usually, power amplifiers operate close to the saturation point where efficiency is maximum. However, at this point, a small increase in input power can push the amplifier from the linear mode to the saturated mode. Thus, to ensure it operates in the linear region, the power level is lowered from the point of maximum efficiency. The value of this power level reduction is power backoff. This means that the higher the power backoff, the smaller is the actual transmit power and coverage. The power backoff is used because the input power level is not constant, but varies quite significantly. This variation is usually characterized by a peak-to-average power ratio (PAPR). The higher the PAPR, the more there are variations in the input power levels, which means that more power backoff is required to ensure the operation in the linear region. PAPR varies also with the modulation scheme, so that lower-order modulations have lower PAPR, and thus require smaller power backoff. The specification defines maximum power reduction (MPR) values for each modulation, which is the allowed reduction of maximum power level (power backoff) which a UE can use for given modulation. Table 6.2.2-1 (Source TS 38.101-1), shown in FIG. 3, shows an example MPR for a FR1 scenario. The reference numbers show the minimum required Tx power for the UE (in dBm) calculated based on MPR and Tx power, namely reference numbers 302, 304, 306, 308, 310, 312, 314, 316, 318, 319, 320, 322, 324, 326, 328, 330, 332, 334, 336, 338, and 340.

In existing systems, one of the main problems is the poor PA efficiency, which decreases when the backoff is increased. This makes the power consumption large: either a larger power amplifier is selected in the design, or transmission times increase for the same amount of data due to lower spectral efficiency. Thus, it would be essential to find techniques to reduce backoff, to enable lower power consumption and improved coverage. However, the problem is that if the backoff is decreased, the distortion (EVM increase) caused by the PA non-linearities grows and makes easily the signal EVM above the tolerable limit for the modulation. Especially the higher order modulations are typically EVM limited, which means that the backoff is made so large that the EVM requirement of the specification is met.

### EVM:

The error vector magnitude is a measure of the difference between the reference waveform and the measured waveform. Table 6.4.2.1-1 (source: TS 38.101-1) shows the existing EVM requirements for an NR UE (FR1).

TABLE 6.4.2.1-1
Requirements for Error Vector Magnitude

| Parameter | Unit | Average EVM Level |
|---|---|---|
| Pi/2-BPSK | % | 30 |
| QPSK | % | 17.5 |
| 16 QAM | % | 12.5 |
| 64 QAM | % | 8 |
| 256 QAM | % | 3.5 |

### Inband Emissions:

The in-band emission (IBE) is defined as the average emission across 12 sub-carriers and as a function of the RB offset from the edge of the allocated UL transmission bandwidth. The in-band emission is measured as the ratio of the UE output power in a non-allocated RB to the UE output power in an allocated RB.

Table 6.4A.2.3-1 shows the current IBE requirements for an NR UE (FR1) (source TS 38.101-1).

TABLE 6.4.2.3-1
Requirements for in-band emissions

| Parameter | | | | Applicable |
|---|---|---|---|---|
| description | Unit | Limit (NOTE 1) | | Frequencies |
| General | dB | max {−25 − 10 · 1og₁₀ (N_{RB}/L_{CRB}), | | Any non-allocated |
| | | 20 · log₁₀ EVM − 3 − 5 · (\|Δ_{RB}\| − 1)/L_{CRB}, | | (NOTE 2) |
| | | −57 dBm + 10 log₁₀ (SCS/15 kHz ) − P̅_̅{̅R̅B̅}̅} | | |
| IQ Image | dB | −28 | Image frequencies when output power > 10 dBm | Image |
| | | | | frequencies |
| | | −25 | Image frequencies when output power ≤ 10 dBm | (NOTES 2, 3) |
| Carrier | dBc | −28 | Output power > 10 dBm | Carrier leakage |
| leakage | | −25 | 0 dBm ≤ Output power ≤ 10 dBm | frequency |
| | | −20 | −30 dBm ≤ Output power < 0 dBm | (NOTES 4, 5) |
| | | −10 | −40 dBm ≤ Output power < −30 dBm | |

NOTE 1:
An in-band emissions combined limit is evaluated in each non-allocated RB. For each such RB, the minimum requirement is calculated as the higher of P̅_̅{̅R̅B̅}̅ − 30 dB and the power sum of all limit values (General, IQ Image or Carrier leakage) that apply. P̅_̅{̅R̅B̅}̅ is defined in NOTE 10.
NOTE 2:
The measurement bandwidth is 1 RB and the limit is expressed as a ratio of measured power in one non-allocated RB to the measured average power per allocated RB, where the averaging is done across all allocated RBs. For pi/2 BPSK with Spectrum Shaping, the limit is expressed as a ratio of measured power in one non-allocated RB to the measured power in the allocated RB with highest PSD.
NOTE 3:
The applicable frequencies for this limit are those that are enclosed in the reflection of the allocated bandwidth, based on symmetry with respect to the carrier leakage frequency, but excluding any allocated RBs.
NOTE 4:
The measurement bandwidth is 1 RB and the limit is expressed as a ratio of measured power in one non-allocated RB to the measured total power in all allocated RBs.
NOTE 5:
The applicable frequencies for this limit depend on the parameter txDirectCurrentLocation in UplinkTxDirectCurrent IE, and are those that are enclosed either in the RB containing the carrier leakage frequency, or in the two RBs immediately adjacent to the carrier leakage frequency but excluding any allocated RB.
NOTE 6:
L_{CRB} is the Transmission Bandwidth (see clause 5.3).
NOTE 7:
N_{RB} is the Transmission Bandwidth Configuration (see clause 5.3).
NOTE 8:
EVM is the limit specified in Table 6.4.2.1-1 for the modulation format used in the allocated RBs.
NOTE 9:
Δ_{RB} is the starting frequency offset between the allocated RB and the measured non-allocated RB (e.g. Δ_{RB} = 1 or Δ_{RB} = −1 for the first adjacent RB outside of the allocated bandwidth.
NOTE 10:
P̅_̅{̅R̅B̅}̅ is an average of the transmitted power over 10 sub-frames normalized by the number of allocated RBs, measured in dBm.
NOTE 11:
For almost contiguous allocations defined in clause 6.2.2, L_{CRB} = N_{RB}_alloc + N_{RB}_gap with no in-gap emission requirement.

### Occupied Bandwidth:

Occupied bandwidth is defined as the bandwidth containing 99% of the total integrated mean power of the transmitted spectrum on the assigned channel. The occupied bandwidth for all transmission bandwidth configurations (resources blocks) shall be less than the channel bandwidth specified in Table 6.5.1-1 (Source: TS 38.101-1) below.

TABLE 6.5.1-1
Occupied channel bandwidth

| | NR channel bandwidth | | | | | | | | | | | | |
|---|---|---|---|---|---|---|---|---|---|---|---|---|---|
| | 5 | 10 | 15 | 20 | 25 | 30 | 40 | 50 | 60 | 70 | 80 | 90 | 100 |
| | MHz | MHz | MHz | MHz | MHz | MHz | MHz | MHz | MHz | MHz | MHz | MHz | MHz |
| Occupied | 5 | 10 | 15 | 20 | 25 | 30 | 40 | 50 | 60 | 70 | 80 | 90 | 100 |
| channel | | | | | | | | | | | | | |
| bandwidth | | | | | | | | | | | | | |
| (MHz) | | | | | | | | | | | | | |

### Spectrum Emission Mask:

The spectrum emission mask of the UE applies to frequencies (ΔfOOB) starting from the ± edge of the assigned NR channel bandwidth. For a frequency offset greater than FOOB as specified in Table 6.5.2.2-1 below the spurious requirements in clause 6.5.3 are applicable. (Source: TS 38.101-1)

TABLE 6.5.2.2-1
General NR spectrum emission mask
Spectrum emission limit (dBm)/Channel bandwidth

| Δf_{OOB} | 5 | 10 | 15 | 20 | 25 | 30 | 40 | 50 | 60 | 70 | 80 | 90 | 100 | Measurement |
|---|---|---|---|---|---|---|---|---|---|---|---|---|---|---|
| (MHz) | MHz | MHz | MHz | MHz | MHz | MHz | MHz | MHz | MHz | MHz | MHz | MHz | MHz | bandwidth |
| ±0-1 | −13 | −13 | −13 | −13 | −13 | −13 | −13 | | | | | | | 1% channel |
| | | | | | | | | | | | | | | bandwidth |
| ±0-1 | | | | | | | | −24 | −24 | −24 | −24 | −24 | −24 | 30 kHz |
| ±1-5 | −10 | −10 | −10 | −10 | −10 | −10 | −10 | −10 | −10 | −10 | −10 | −10 | −10 | 1 MHz |
| ±5-6 | −13 | −13 | −13 | −13 | −13 | −13 | −13 | −13 | −13 | −13 | −13 | −13 | −13 | |
| ±6-10 | −25 | | | | | | | | | | | | | |
| ±10-15 | | −25 | | | | | | | | | | | | |
| ±15-20 | | | −25 | | | | | | | | | | | |
| ±20-25 | | | | −25 | | | | | | | | | | |
| ±25-30 | | | | | −25 | | | | | | | | | |
| ±30-35 | | | | | | −25 | | | | | | | | |
| ±35-40 | | | | | | | | | | | | | | |
| ±40-45 | | | | | | | −25 | | | | | | | |
| ±45-50 | | | | | | | | | | | | | | |
| ±50-55 | | | | | | | | −25 | | | | | | |
| ±55-60 | | | | | | | | | | | | | | |
| ±60-65 | | | | | | | | | −25 | | | | | |
| ±65-70 | | | | | | | | | | | | | | |
| ±70-75 | | | | | | | | | | −25 | | | | |
| ±75-80 | | | | | | | | | | | | | | |
| ±80-85 | | | | | | | | | | | −25 | | | |
| ±85-90 | | | | | | | | | | | | | | |
| ±90-95 | | | | | | | | | | | | −25 | | |
| ±95-100 | | | | | | | | | | | | | | |
| ±100-105 | | | | | | | | | | | | | −25 | |

International patent application no. PCT/EP2020/078335 and Finnish patent application no. 20215502 propose frameworks to perform PA distortion compensation at the receiver side. The non-linear distortion compensation in the receiver is possible when the proper receiver processing is used. The main benefits of the methods are to enable higher transmit power and/or EVM by the transmitter, because the receiver can then compensate the increased distortion.

The RF requirements in the specification are defined so that the transmit signal quality is kept in a tolerable limit for a given modulation, so that the receiver would be able to decode the signal. However, this becomes a limiting factor if the state-of-the-art method with PA distortion compensation is used in the receiver side (as proposed e.g. in international patent application no. PCT/EP2020/078335 and Finnish patent application no. 20215502).

In order to achieve the gains provided by the PA distortion compensation at the receiver side, new RF requirements have to be defined in the specification. This is due to the fact that the current EVM and MPR requirements are defined for the system where the PA non-linearity is not a problem (illustrated in the MPR and EVM tables from the specification, including Table 6.4.2.1-1 and Table 6.2.2-1). The gains of distortion compensation are enabled if the UE increases the transmit power, and the transmit signal gets more distorted. This in turn means that the EVM increases because of the PA non-linearity. This requires a new method for power control in order to achieve the gains.

Such gains cannot be provided by current UL power control methods, because UEs do not have means to control their power beyond their pre-defined TX quality limit, such that the transmitters have to be initially designed so as to fulfill this specific limit, and power can be only controlled between MPR and the UE's maximum power to fulfill the limit.

Currently, Tx signal quality is defined according to the assumption of a linear receiver at the gNB (i.e. such a receiver that cannot mitigate the PA distortion). Advanced receivers cannot provide coverage gain on top of the current specification (since there is no significant non-linear distortion to mitigate).

The goal of the examples described herein is to allow non-linear distortion. Operating at the non-linear region provides a higher Tx power and coverage gain. But, this is against the philosophy used in the current specification (which tries to minimize the distortion).

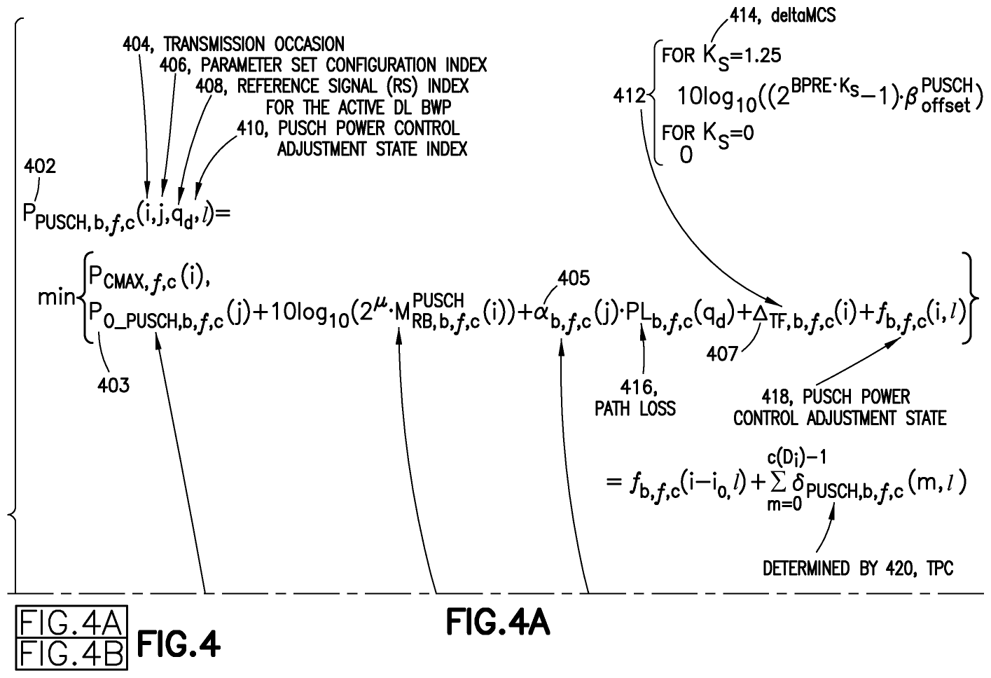

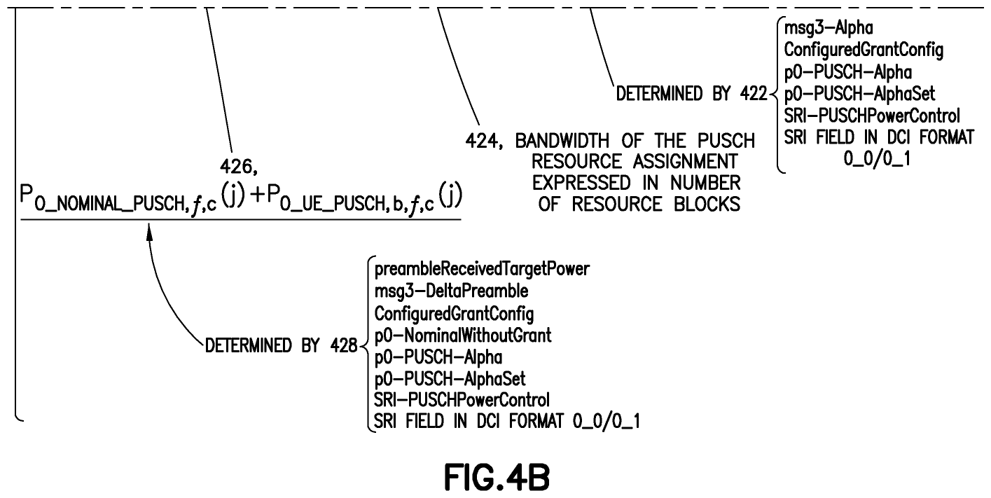

UL power control in 5G determines a power for PUSCH, PUCCH, SRS, and PRACH transmissions. FIG. 4 shows the equation 402 for PUSCH power control. The equation 402 for PUSCH power control depends on a pre-configured received power target assuming full PL compensation (P_0) 403, bandwidth (M) 424, path loss 416 and fractional power control factor 405 (α*PL), MCS dependent component (Delta) 407, and closed loop power control component 418 which depends on transmit power control command (TPC) in DCI (referring to 420).

FIG. 4 shows other aspects of the equation 402 for PUSCH power control, including transmission occasion 404, parameter set configuration index 406, reference signal (RS) index for the active DL BWP 408, and PUSCH power control adjustment state index 410. Full PL compensation (P_0) 403 includes a nominal and UE component (collectively 426), that is determined by a preamble received target power, a msg3 delta preamble, a configured grant configuration, PO nominal without grant, PO PUSCH alpha, P0 PUSCH alpha set, SRI PUSCH power control, and SRI field in DCI format 0_0/0_1 (collectively 428). The fractional power control factor 405 is determined by msg3 alpha, the configured grant configuration, P0 PUSCH alpha, P0 PUSCH alpha set, SRI PUSCH power control, and an SRI field in DCI format 0_0/0_1 (collectively 422). MCS dependent component (Delta) 407 is determined by logic 412 that takes into consideration delta MCS 414.

In future systems, if the transmitters are allowed to transmit with different TX quality levels, this needs to be taken into account in the power control.

Tx signal quality has been defined carefully in LTE and NR (this is needed in order to guarantee the QOS: capacity, coverage, latency, . . . ). EVM and IBE are used to define signal inband signal quality. OCB and ACLR are used to define signal quality outside the channel bandwidth.

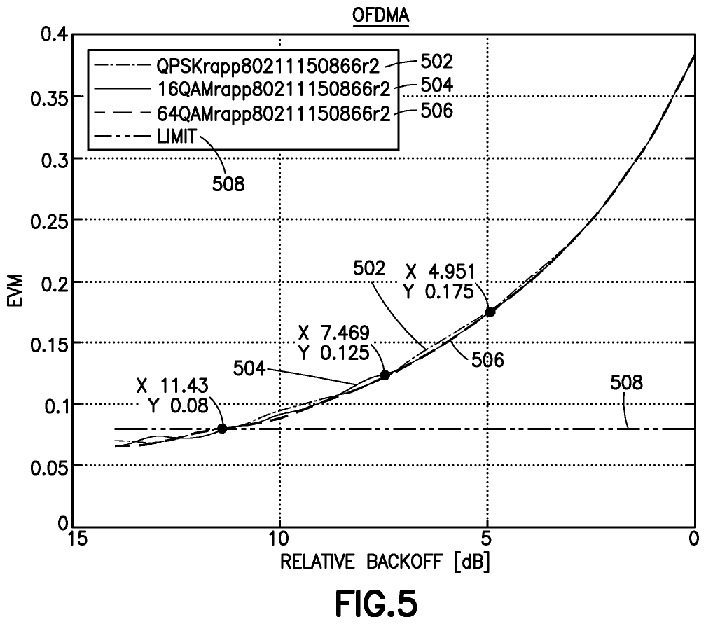

An increase of the Tx power worsens the Tx signal quality. This is seen in FIG. 5. EVM is the considered quality metric: the smaller the EVM, the better the signal quality. OBO is the considered power metric: the smaller the OBO, the higher the achievable Tx power.

In order to achieve trade-off between a reasonable implementation complexity and the required Tx power, the UE is allowed to reduce the maximum Tx power. This is controlled by the MPR (Maximum Power Reduction) parameter (this can be seen as the 3GPP realization for allowed OBO). MPR (dB) indicates the minimum required Tx power for the UE. MPR varies according to the PRB allocation, modulation scheme, etc.

The current philosophy in defining RF requirements is the following. The EVM requirement is defined for different modulation schemes such that PA does not distort the signal too much (this is due to the fact that the receiver cannot mitigate non-linear distortion). MPR is defined for different scenarios such that a reasonably high Tx power level can be achieved while meeting the predefined Tx signal quality requirements (IBE, ACLR, OCB, EVM).

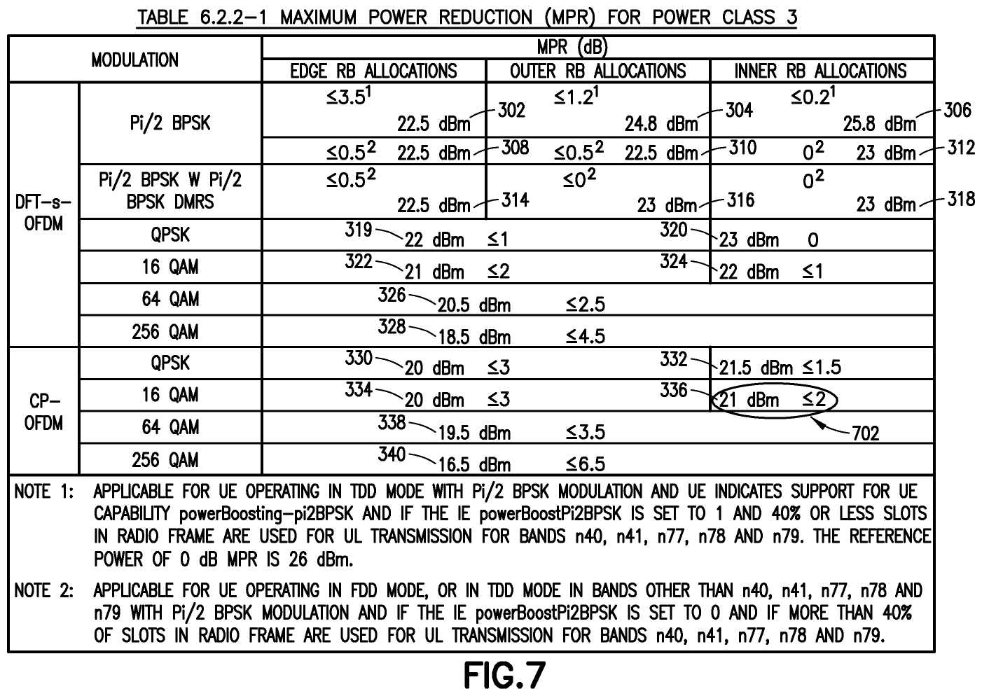

The current specification defines MPR and EVM requirements as illustrated in Table 6.2.2-1 (FIG. 3 and FIG. 7) and Table 6.4.2.1-1 as an example. These requirements are defined so that the transmit signal quality is kept within a tolerable limit for a given modulation, so that the receiver is able to decode the signal. For example, for higher-order modulations the MPR is defined so that the EVM after the power amplifier is small enough.

An approach is based on the following method: a) define conditions where certain UE requirements (for at least one UE) can be relaxed with respect to the existing specifications. The foreseen UE requirements are IBE and EVM but other requirements can be considered according to the same principles. b) define relaxed requirements (and corresponding UE behavior) for the defined conditions. c) determine the usage of relaxed requirements based on the received scheduling grant:
if the condition is fulfilled
   determine UE Tx power at least partially based on the relaxed requirements
else
   determine UE Tx power at least partially based on the existing requirements
end.

Another approach considers the scenario that some implementations, for example, the UE may follow modified requirements (e.g., relaxed EVM requirements or tightened maximum power reduction (MPR) requirements) for transmitting the training reference signals.

The problem of these approaches discussed is that they just hint that the EVM requirement can be relaxed but they do not say how it is done. Instead, they propose that the gNB is just switching between two regulatory frameworks.

Another approach involves a framework where in some scenarios, the UE can switch to use a relaxed EVM requirement so that MPR is then increased.

However, the MPR requirement is not a well applicable requirement in this case, because i) MPR defines only the maximum allowed power reduction, which means that UE can use any backoff value smaller than this in practice; ii) if the MPR requirement is increased, it means that the UE has to increase TX power (reduce backoff), so it would be forced to do it; iii) if there is a single relaxed EVM requirement, the actual modulation quality (actual EVM or backoff) would not be still controlled because the transmitter and receiver would not know what would be the actual EVM and how much the receiver would tolerate; and iv) distortion compensation capability may be highly receiver implementation dependent, i.e., even though there is compensation, different receivers may tolerate different levels of EVM.

The advanced receiver does not necessarily need to be ML-based. For instance in receiver-side nonlinearities mitigation using an extended iterative decision-based technique, the non-linear distortion is compensated by means of an iterative decision-based technique at the receiver side. To achieve the goal, the nonlinear PA model needs to be estimated, or known to the receiver.

The proposed method provides means to improve UL coverage while ensuring predictable and good receiver performance. This is achieved by quality aware UL power control involving a plurality of Tx quality classes per waveform and modulation order. The TX quality class defines the UEs RF performance region in different transmit power regions. The proposed solution involves the following elements.

First, this involves a new notion of TX quality class. The power control range is divided into a plurality (i.e. at least two) of TX quality classes. Each TX quality class has at least one TX quality class specific quality target (e.g. EVM example below) and at least one TX quality class specific MPR value (see numerical examples in implementation section).

The quality targets (EVM, MPR) can be defined separately for each modulation scheme, for DFT-S-OFDM and OFDM waveforms, for different RB allocations (edge, outer, inner), and for different UE power classes (such as PC3, PC2, . . . ). The quality targets can be defined separately also for different UL carrier aggregation scenarios.

The rationale behind the new TX quality class definition is that because the receiver is able to compensate a specific amount of EVM, the gNB may utilize this if the UE is required to transmit with higher power.

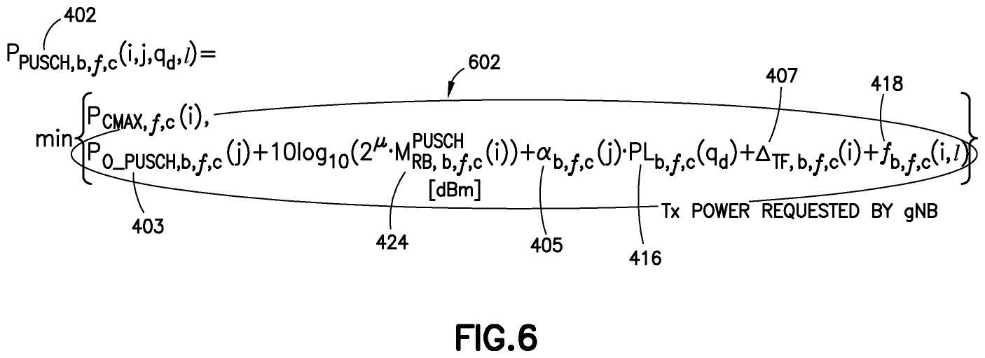

When operating according to the herein described solution, with reference to FIG. 6, the UE determines the Tx power requested by the gNB (602). This can be done based on the current Tx power formula 402. The needed parameters are determined based on the UL grant. The UL grant contains information for the UL Tx regulatory framework (legacy vs. “relaxed requirements”).

If the UE Tx regulatory framework is “relaxed requirements” (if not, UE just follows the legacy requirements), the UE determines the Tx quality class based on the Tx power requested by gNB. The example below shows the case with four Tx quality classes. In the preferred example embodiment, legacy requirements are applied for the cases when Tx power requested by gNB is below or within a threshold (21 dBm in the example below).

| Tx power requested by gNB | | TX quality |
|---|---|---|
| Lower limit (dBm) | Upper limit (dBm) | class |
| >23 | None | 4 |
| 22 | 23 | 3 |
| 21 | 22 | 2 |
| None | 21 | 1 |

The UE 110 determines an output power value based on the Tx quality class. The output power value is determined according to Tx quality class-specific quality metrics, including at least a Tx quality class-specific EVM, and a Tx quality class-specific MPR. Depending on the example embodiment, there can be other Tx quality class-specific quality metrics (e.g. A-MPR).

The UE determines the actual UL Tx power (e.g. similarly to current PC formula 402, but instead involving min (output power value, “Tx power requested by gNB” 602). This may involve determination of the Tx quality-class specific MPR and the related minimum power. The UE transmits an uplink transmission on PUSCH or PUCCH according to the actual UL Tx power.

In mathematical terms, the output power value≥(P_{CMAX}−allowed MPR defined for the power transmission quality class). P_{CMAX} iS the maximum Tx power defined for the power class (e.g. 23 dBm for power class 3). The output power value may depend on the UE implementation choices, and may vary from one scenario to another.

The usage of the quality aware UL power control may be limited to the cases where UE is operating according to “relaxed Tx requirements”. When the UE transmits a PHR (power headroom report), the UE may have determined the PHR according to the used power control principle. Power headroom indicates how much transmission power is left for a UE to use in addition to the power being used by the current transmission. The current PHR reporting range is from −23 to 40 dB, with 1 dB resolution.

In an example embodiment the TX quality class definition involves different EVM and/or MPR requirements for different number of DAC bits in the transmitter. The lower the number of DAC bits, the higher the EVM and thus either the EVM requirement has to be looser or the MPR requirement has to be looser. The motivation behind this is that the UE can save lots of energy e.g., in the non-power limited cases, where the UE can drop the number of DAC bits if the UE is allowed to transmit in different TX quality class.

In the preferred example embodiment, the new framework determination has no impact to ACLR, OCB, and IBE requirements. Similar requirements can be defined also if any other machine learning based techniques would be used to improve the receiver performance significantly in the future.

Determining the EVM/MPR values for different Tx quality classes comprises the following methodology.

### EVM

The basic principle is to tabulate the EVM requirements in the specification.

In an example embodiment, an EVM limit for a modulation order may be defined according to the higher order modulation (see example table below, and reference in the specification). This would be an especially good option for OFDM where the modulations are mostly limited by EVM.

| | | Average EVM level | Average EVM level |
|---|---|---|---|
| Parameter | Unit | Legacy PC | Quality aware PC |
| Pi/2 BPSK | % | 30 | 35 |
| QPSK | % | 17.5 | 30 |
| 16QAM | % | 12.5 | 17.5 |
| 64QAM | % | 8 | 12.5 |
| 256QAM | % | 3.5 | 8 |

### EVM/MPR

An example table from the definition of new classes is illustrated in the Table below. In other words, it is related to one cell 702 of current Table 6.2.2-1 (refer to FIG. 7). Similar extensions can be defined for other scenarios. It is expected that the biggest impact is for cells with “inner RB allocations” since those are often EVM-limited.

UE capabilities: support for different Tx quality classes May be based on UE capability. For example, certain UEs may support only Tx quality class #1 and #2, while some other UEs support all classes (#1-4).

| | EXAMPLES OF HOW DIFFERENT UE capabilities | | | |
|---|---|---|---|---|
| | CAN SATISFY THE NEW TX quality | | | |
| | classes for certain modulation (16QAM), waveform | | | |
| | (OFDM) and PRB range (inner RB allocations), PC3 | | | |
| TX | Allowed | | P_{CMAX, f, c}- | |
| quality | EVM | | allowed MPR | |
| class | (%) | Allowed MPR (dB) | (dB) | Note |
| 4 | 30 | 0 | 23 | Relaxed |
| | | | | requirements |
| 3 | 25 | ≤1 | 22 | Relaxed |
| | | | | requirements |
| 2 | 20 | ≤1.5 | 21.5 | Relaxed |
| | | | | requirements |
| 1 | 12.5 | ≤2 | 21 | Legacy |
| | | | | requirements |

When considering a certain scenario (a waveform, a modulation scheme, a power class, and an RB allocation) the MPR may be defined separately for each of the transmission quality classes. In the preferred example embodiment, a “certain scenario” contains at least two unique (or Tx quality class specific) MPR values.

Advantages and technical effects of the herein described method include that the herein described method enables PA distortion compensation at the receiver so that the power allocation is well and flexibly controlled, and the BS receiver then knows which level of EVM it is able to tolerate and compensate. This enables improved coverage and support for various quality levels for devices, which is especially important in the future. Further, the herein described method allows an AI/ML-type of receiver for the gNB with minor standard impact.

The herein described idea may be published in NR Rel-18 (AIML). The examples described herein may require standardization.

Thus, the examples described herein relate to TX quality aware uplink power control. The described method provides means to improve UL coverage while ensuring predictable and good receiver performance. The quality aware UL power control involves a plurality of Tx quality classes per waveform and modulation order. The TX quality class defines the UE's RF performance region in different transmit power regions. The power control range is divided into a plurality of (i.e. at least two) TX quality classes. Each TX quality class has at least one TX quality class specific quality target and at least one TX quality class specific MPR value. The quality targets (EVM, MPR) can be defined separately at least 1) for each modulation scheme, 2) for DFT-S-OFDM and OFDM waveforms, 3) for different RB allocations (edge, outer, inner), and 4) for different UE power classes (such as PC3, PC2, etc.). The UE determines the Tx power requested by the gNB. This can be done based on the current Tx power formula. The needed parameters are determined based on a UL grant. The UL grant contains information for the UL Tx regulatory framework. If the UE Tx regulatory framework is “relaxed requirements”, then 1) the UE determines the Tx quality class based on the Tx power requested by gNB, and 2) in the preferred example embodiment, legacy requirements are applied for the cases when Tx power requested by gNB is below or within a threshold.

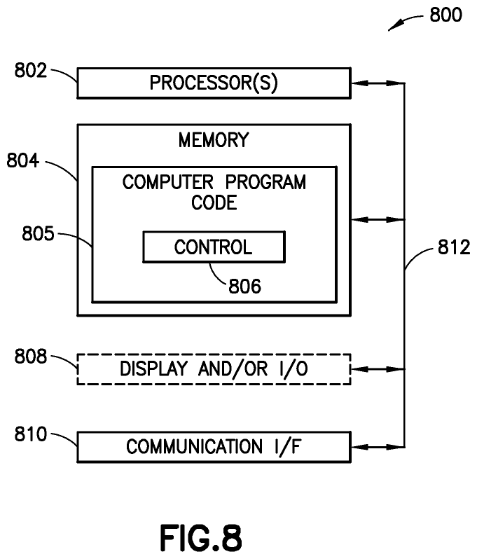

FIG. 8 is an example apparatus 800, which may be implemented in hardware, configured to implement the examples described herein. The apparatus 800 comprises at least one processor 802 (e.g. an FPGA and/or CPU), at least one memory 804 including computer program code 805, wherein the at least one memory 804 and the computer program code 805 are configured to, with the at least one processor 802, cause the apparatus 800 to implement circuitry, a process, module, component, or function (collectively control 806) to implement the examples described herein, including TX quality aware uplink power control. The memory 804 may be a non-transitory memory, a transitory memory, a volatile memory (e.g. RAM), or a non-volatile memory (e.g. ROM).

The apparatus 800 optionally includes a display and/or I/O interface 808 that may be used to display aspects or a status of the methods described herein (e.g., as one of the methods is being performed or at a subsequent time), or to receive input from a user such as with using a keypad, camera, touchscreen, touch area, microphone, etc. The apparatus 800 includes one or more communication e.g. network (N/W) interfaces (I/F(s)) 810. The communication I/F(s) 810 may be wired and/or wireless and communicate over the Internet/other network(s) via any communication technique. The communication I/F(s) 810 may comprise one or more transmitters and one or more receivers.

The communication I/F(s) 810 may comprise standard well-known components such as an amplifier, filter, frequency-converter, (de) modulator, and encoder/decoder circuitries and one or more antennas.

The apparatus 800 to implement the functionality of control 806 may be UE 110, RAN node 170 (e.g. gNB), or network element(s) 190. Thus, processor 802 may correspond respectively to processor(s) 120, processor(s) 152 and/or processor(s) 175, memory 804 may correspond respectively to memory(ies) 125, memory(ies) 155 and/or memory(ies) 171, computer program code 805 may correspond respectively to computer program code 123, module 140-1, module 140-2, and/or computer program code 153, module 150-1, module 150-2, and/or computer program code 173, and communication I/F(s) 810 may correspond respectively to transceiver 130, antenna(s) 128, transceiver 160, antenna(s) 158, N/W I/F(s) 161, and/or N/W I/F(s) 180. Alternatively, apparatus 800 may not correspond to either of UE 110, RAN node 170, or network element(s) 190, as apparatus 800 may be part of a self-organizing/optimizing network (SON) node, such as in a cloud.

The apparatus 800 may also be distributed throughout the network (e.g. 100) including within and between apparatus 800 and any network element (such as a network control element (NCE) 190 and/or the RAN node 170 and/or the UE 110).

Interface 812 enables data communication between the various items of apparatus 800, as shown in FIG. 8. For example, the interface 812 may be one or more buses such as address, data, or control buses, and may include any interconnection mechanism, such as a series of lines on a motherboard or integrated circuit, fiber optics or other optical communication equipment, and the like. Computer program code 805, including control 806 may comprise object-oriented software configured to pass data/messages between objects within computer program code 805. The apparatus 800 need not comprise each of the features mentioned, or may comprise other features as well.

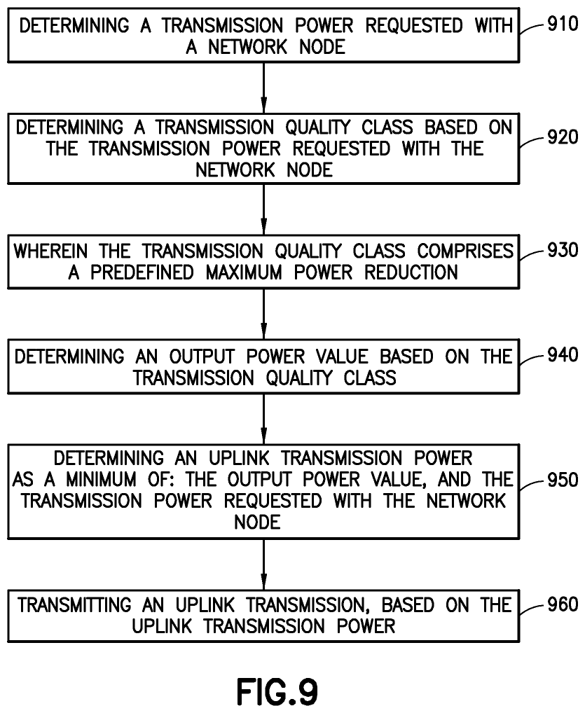

FIG. 9 is an example method 900 to implement the example embodiments described herein. At 910, the method includes determining a transmission power requested with a network node. At 920, the method includes determining a transmission quality class based on the transmission power requested with the network node. At 930, the method includes wherein the transmission quality class comprises a predefined maximum power reduction. At 940, the method includes determining an output power value based on the transmission quality class. At 950, the method includes determining an uplink transmission power as a minimum of: the output power value, and the transmission power requested with the network node. At 960, the method includes transmitting an uplink transmission, based on the uplink transmission power. Method 900 may be performed with a user equipment (e.g. UE 110).

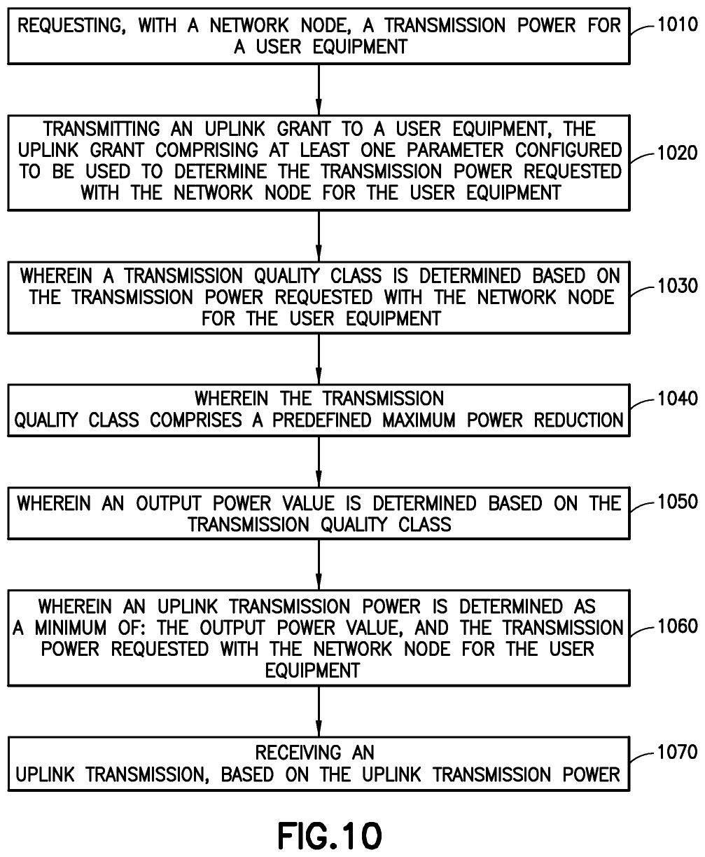

FIG. 10 is an example method 1000 to implement the example embodiments described herein. At 1010, the method includes requesting, with a network node, a transmission power for a user equipment. At 1020, the method includes transmitting an uplink grant to a user equipment, the uplink grant comprising at least one parameter configured to be used to determine the transmission power requested with the network node for the user equipment. At 1030, the method includes wherein a transmission quality class is determined based on the transmission power requested with the network node for the user equipment. At 1040, the method includes wherein the transmission quality class comprises a predefined maximum power reduction. At 1050, the method includes wherein an output power value is determined based on the transmission quality class. At 1060, the method includes wherein an uplink transmission power is determined as a minimum of: the output power value, and the transmission power requested with the network node for the user equipment. At 1070, the method includes receiving an uplink transmission, based on the uplink transmission power. Method 1000 may be performed with an access node (e.g. RAN node 170).

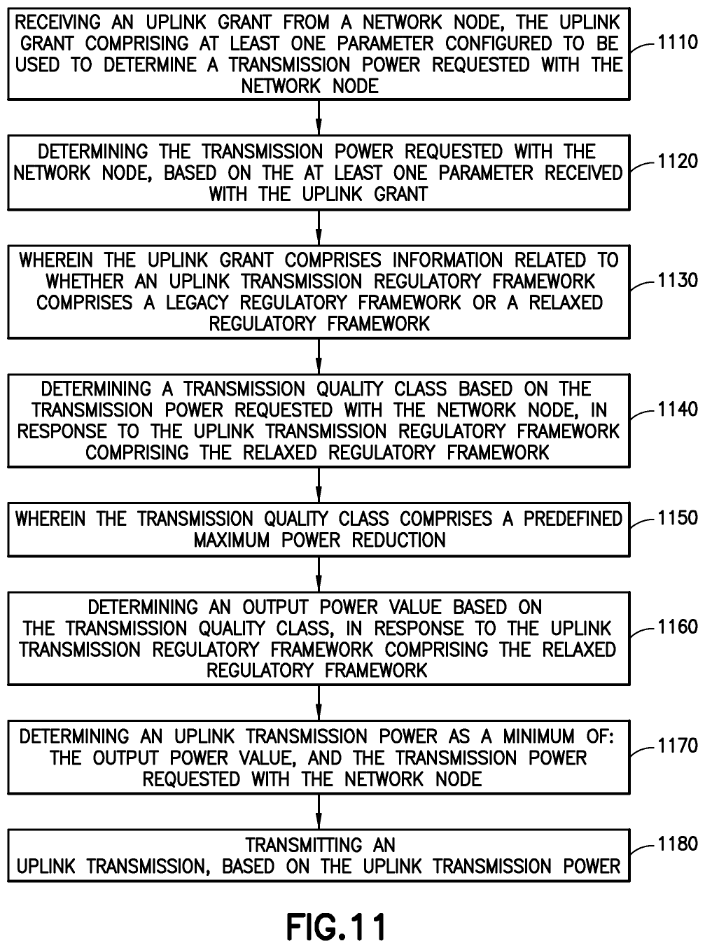

FIG. 11 is an example method 1100 to implement the example embodiments described herein. At 1110, the method includes receiving an uplink grant from a network node, the uplink grant comprising at least one parameter configured to be used to determine a transmission power requested with the network node. At 1120, the method includes determining the transmission power requested with the network node, based on the at least one parameter received with the uplink grant. At 1130, the method includes wherein the uplink grant comprises information related to whether an uplink transmission regulatory framework comprises a legacy regulatory framework or a relaxed regulatory framework. At 1140, the method includes determining a transmission quality class based on the transmission power requested with the network node, in response to the uplink transmission regulatory framework comprising the relaxed regulatory framework. At 1150, the method includes wherein the transmission quality class comprises a predefined maximum power reduction. At 1160, the method includes determining an output power value based on the transmission quality class, in response to the uplink transmission regulatory framework comprising the relaxed regulatory framework. At 1170, the method includes determining an uplink transmission power as a minimum of: the output power value, and the transmission power requested with the network node. At 1180, the method includes transmitting an uplink transmission, based on the uplink transmission power. Method 1100 may be performed with a user equipment (e.g. UE 110).

The following examples (1-62) are provided and described herein.

Example 1: An apparatus includes at least one processor; and at least one memory including computer program code; wherein the at least one memory and the computer program code are configured to, with the at least one processor, cause the apparatus at least to: determine a transmission power requested with a network node; determine a transmission quality class based on the transmission power requested with the network node; wherein the transmission quality class comprises a predefined maximum power reduction; determine an output power value based on the transmission quality class; determine an uplink transmission power as a minimum of: the output power value, and the transmission power requested with the network node; and transmit an uplink transmission, based on the uplink transmission power.

Example 2: The apparatus of example 1, wherein: the output power value is smaller than or equal to a maximum output power for a considered user equipment power class; and the output power value is larger than or equal to: the maximum output power for the considered user equipment power class minus the predefined maximum power reduction defined for the determined transmission quality class.

Example 3: The apparatus of any of examples 1 to 2, wherein the uplink transmission is transmitted on a physical uplink shared channel or on a physical uplink control channel.

Example 4: The apparatus of any of examples 1 to 3, wherein the at least one memory and the computer program code are further configured to, with the at least one processor, cause the apparatus at least to: receive an uplink grant from the network node, the uplink grant comprising at least one parameter configured to be used to determine the transmission power requested with the network node; and determine the transmission power requested with the network node based on a transmission power formula and the at least one parameter.

Example 5: The apparatus of any of examples 1 to 4, wherein the at least one memory and the computer program code are further configured to, with the at least one processor, cause the apparatus at least to: receive an uplink grant from the network node, the uplink grant comprising information related to whether an uplink transmission regulatory framework comprises a legacy regulatory framework or a relaxed regulatory framework; determine the transmission quality class based on the legacy regulatory framework, in response to the uplink transmission regulatory framework comprising the legacy regulatory framework, or determine the transmission quality class based on the legacy regulatory framework, in response to the transmission power requested with the network node being at or below a threshold.

Example 6: The apparatus of any of examples 1 to 5, wherein a power control range has been partitioned into at least two transmission quality classes comprising the transmission quality class, and the transmission quality class comprises at least one quality target.

Example 7: The apparatus of any of examples 1 to 6, wherein the transmission quality class is defined based on at least one of: a quality target; an error vector magnitude; a maximum power reduction; a modulation order or scheme; a waveform; a resource block allocation; or a power class.

Example 8: The apparatus of any of examples 1 to 7, wherein the at least one memory and the computer program code are further configured to, with the at least one processor, cause the apparatus at least to: transmit, from a user equipment to the network node, an indication indicating a capability of the user equipment to support a transmission quality class.

Example 9: The apparatus of any of examples 1 to 8, further comprising a transmitter having a number of digital to analog bits.

Example 10: The apparatus of example 9, wherein the transmission quality class is defined based on an error vector magnitude and a relationship such that the error vector magnitude is higher for a lower number of digital to analog bits within the transmitter.

Example 11: The apparatus of any of examples 9 to 10, wherein the predefined maximum power reduction is higher for a lower number of digital to analog bits within the transmitter.

Example 12: The apparatus of any of examples 1 to 11, wherein the transmission quality class is one of a number of transmission quality classes defined discretely based on a plurality of ranges of the transmission power requested with the network node.

Example 13: The apparatus of any of examples 1 to 12, wherein the transmission quality class is defined based on an error vector magnitude limit for a modulation order.

Example 14: The apparatus of any of examples 1 to 13, wherein the transmission quality class for a scenario comprises a more relaxed quality target for a smaller predefined maximum power reduction.

Example 15: The apparatus of example 14, wherein the scenario comprises a modulation.

Example 16: The apparatus of any of examples 14 to 15, wherein the scenario comprises a waveform.

Example 17: The apparatus of any of examples 14 to 16, wherein the relaxed quality target comprises a higher error vector magnitude.

Example 18: The apparatus of any of examples 1 to 17, wherein the transmission quality class is defined based on an allowed error vector magnitude, an allowed maximum power reduction, and/or a configured output power.

Example 19: An apparatus includes at least one processor; and at least one memory including computer program code; wherein the at least one memory and the computer program code are configured to, with the at least one processor, cause the apparatus at least to: request, with a network node, a transmission power for a user equipment; transmit an uplink grant to a user equipment, the uplink grant comprising at least one parameter configured to be used to determine the transmission power requested with the network node for the user equipment; wherein a transmission quality class is determined based on the transmission power requested with the network node for the user equipment; wherein the transmission quality class comprises a predefined maximum power reduction; wherein an output power value is determined based on the transmission quality class; wherein an uplink transmission power is determined as a minimum of: the output power value, and the transmission power requested with the network node for the user equipment; and receive an uplink transmission, based on the uplink transmission power.

Example 20: The apparatus of example 19, wherein: the uplink grant comprises information related to whether an uplink transmission regulatory framework comprises a legacy regulatory framework or a relaxed regulatory framework; the transmission quality class is determined based on the legacy regulatory framework, in response to the uplink transmission regulatory framework comprising the legacy regulatory framework, or the transmission quality class is determined based on the legacy regulatory framework, in response to the transmission power requested with the network node for the user equipment being at or below a threshold.

Example 21: The apparatus of any of examples 19 to 20, wherein a power control range has been partitioned into at least two transmission quality classes comprising the transmission quality class, and the transmission quality class comprises at least one quality target.

Example 22: The apparatus of any of examples 19 to 21, wherein the transmission quality class is defined based on at least one of: a quality target; an error vector magnitude; a maximum power reduction; a modulation order or scheme; a waveform; a resource block allocation; or a power class.

Example 23: The apparatus of any of examples 19 to 22, wherein the at least one memory and the computer program code are further configured to, with the at least one processor, cause the apparatus at least to: receive, with the network node from the user equipment, an indication indicating a capability of the user equipment to support a transmission quality class.

Example 24: The apparatus of any of examples 19 to 23, wherein the transmission quality class is one of a number of transmission quality classes defined discretely based on a plurality of ranges of the transmission power requested with the network node for the user equipment.

Example 25: An apparatus includes at least one processor; and at least one memory including computer program code; wherein the at least one memory and the computer program code are configured to, with the at least one processor, cause the apparatus at least to: receive an uplink grant from a network node, the uplink grant comprising at least one parameter configured to be used to determine a transmission power requested with the network node; determine the transmission power requested with the network node, based on the at least one parameter received with the uplink grant; wherein the uplink grant comprises information related to whether an uplink transmission regulatory framework comprises a legacy regulatory framework or a relaxed regulatory framework; determine a transmission quality class based on the transmission power requested with the network node, in response to the uplink transmission regulatory framework comprising the relaxed regulatory framework; wherein the transmission quality class comprises a predefined maximum power reduction; determine an output power value based on the transmission quality class, in response to the uplink transmission regulatory framework comprising the relaxed regulatory framework; determine an uplink transmission power as a minimum of: the output power value, and the transmission power requested with the network node; and transmit an uplink transmission, based on the uplink transmission power.

Example 26: The apparatus of example 25, wherein the at least one memory and the computer program code are further configured to, with the at least one processor, cause the apparatus at least to: determine the output power value based on the legacy regulatory framework, in response to the uplink transmission regulatory framework comprising the legacy regulatory framework; or determine the output power value based on the legacy regulatory framework, in response to the transmission power requested with a network node being at or below a threshold; or determine the transmission quality class based on the legacy regulatory framework, in response to the uplink transmission regulatory framework comprising the legacy regulatory framework.

Example 27: The apparatus of any of examples 25 to 26, wherein the transmission quality class is one of a number of transmission quality classes defined discretely based on a plurality of ranges of the transmission power requested with the network node.

Example 28: The apparatus of any of examples 25 to 27, wherein the transmission quality class is defined based on an error vector magnitude limit for a modulation order.

Example 29: A method includes determining a transmission power requested with a network determining a transmission quality class based on the transmission power requested with the network node; wherein the transmission quality class comprises a predefined maximum power reduction; determining an output power value based on the transmission quality class; determining an uplink transmission power as a minimum of: the output power value, and the transmission power requested with the network node; and transmitting an uplink transmission, based on the uplink transmission power.

Example 30: The method of example 29, wherein: the output power value is smaller than or equal to a maximum output power for a considered user equipment power class; and the output power value is larger than or equal to: the maximum output power for the considered user equipment power class minus the predefined maximum power reduction defined for the determined transmission quality class.

Example 31: The method of any of examples 29 to 30, wherein the uplink transmission is transmitted on a physical uplink shared channel or on a physical uplink control channel.

Example 32: The method of any of examples 29 to 31, further comprising: receiving an uplink grant from the network node, the uplink grant comprising at least one parameter configured to be used to determine the transmission power requested with the network node; and determining the transmission power requested with the network node based on a transmission power formula and the at least one parameter.

Example 33: The method of any of examples 29 to 32, further comprising: receiving an uplink grant from the network node, the uplink grant comprising information related to whether an uplink transmission regulatory framework comprises a legacy regulatory framework or a relaxed regulatory framework; determining the transmission quality class based on the legacy regulatory framework, in response to the uplink transmission regulatory framework comprising the legacy regulatory framework, or determining the transmission quality class based on the legacy regulatory framework, in response to the transmission power requested with the network node being at or below a threshold.

Example 34: The method of any of examples 29 to 33, wherein a power control range has been partitioned into at least two transmission quality classes comprising the transmission quality class, and the transmission quality class comprises at least one quality target.

Example 35: The method of any of examples 29 to 34, wherein the transmission quality class is defined based on at least one of: a quality target; an error vector magnitude; a maximum power reduction; a modulation order or scheme; a waveform; a resource block allocation; or a power class

Example 36: The method of any of examples 29 to 35, further comprising: transmitting, from a user equipment to the network node, an indication indicating a capability of the user equipment to support a transmission quality class.

Example 37: The method of any of examples 29 to 36, wherein an apparatus performing the method comprises a transmitter having a number of digital to analog bits.

Example 38: The method of example 37, wherein the transmission quality class is defined based on an error vector magnitude and a relationship such that the error vector magnitude is higher for a lower number of digital to analog bits within the transmitter.

Example 39: The method of any of examples 37 to 38, wherein the predefined maximum power reduction is higher for a lower number of digital to analog bits within the transmitter.

Example 40: The method of any of examples 29 to 39, wherein the transmission quality class is one of a number of transmission quality classes defined discretely based on a plurality of ranges of the transmission power requested with the network node.

Example 41: The method of any of examples 29 to 40, wherein the transmission quality class is defined based on an error vector magnitude limit for a modulation order.

Example 42: The method of any of examples 29 to 41, wherein the transmission quality class for a scenario comprises a more relaxed quality target for a smaller predefined maximum power reduction.

Example 43: The method of example 42, wherein the scenario comprises a modulation.

Example 44: The method of any of examples 42 to 43, wherein the scenario comprises a waveform.

Example 45: The method of any of examples 42 to 44, wherein the relaxed quality target comprises a higher error vector magnitude.

Example 46: The method of any of examples 29 to 45, wherein the transmission quality class is defined based on an allowed error vector magnitude, an allowed maximum power reduction, and/or a configured output power.

Example 47: A method includes requesting, with a network node, a transmission power for a user equipment; transmitting an uplink grant to a user equipment, the uplink grant comprising at least one parameter configured to be used to determine the transmission power requested with the network node for the user equipment; wherein a transmission quality class is determined based on the transmission power requested with the network node for the user equipment; wherein the transmission quality class comprises a predefined maximum power reduction; wherein an output power value is determined based on the transmission quality class; wherein an uplink transmission power is determined as a minimum of: the output power value, and the transmission power requested with the network node for the user equipment; and receiving an uplink transmission, based on the uplink transmission power.

Example 48: The method of example 47, wherein: the uplink grant comprises information related to whether an uplink transmission regulatory framework comprises a legacy regulatory framework or a relaxed regulatory framework; the transmission quality class is determined based on the legacy regulatory framework, in response to the uplink transmission regulatory framework comprising the legacy regulatory framework, or the transmission quality class is determined based on the legacy regulatory framework, in response to the transmission power requested with the network node for the user equipment being at or below a threshold.

Example 49: The method of any of examples 47 to 48, wherein a power control range has been partitioned into at least two transmission quality classes comprising the transmission quality class, and the transmission quality class comprises at least one quality target.

Example 50: The method of any of examples 47 to 49, wherein the transmission quality class is defined based on at least one of: a quality target; an error vector magnitude; a maximum power reduction; a modulation order or scheme; a waveform; a resource block allocation; or a power class.

Example 51: The method of any of examples 47 to 50, further comprising: receiving, with the network node from the user equipment, an indication indicating a capability of the user equipment to support a transmission quality class.

Example 52: The method of any of examples 47 to 51, wherein the transmission quality class is one of a number of transmission quality classes defined discretely based on a plurality of ranges of the transmission power requested with the network node for the user equipment.

Example 53: A method includes receiving an uplink grant from a network node, the uplink grant comprising at least one parameter configured to be used to determine a transmission power requested with the network node; determining the transmission power requested with the network node, based on the at least one parameter received with the uplink grant; wherein the uplink grant comprises information related to whether an uplink transmission regulatory framework comprises a legacy regulatory framework or a relaxed regulatory framework; determining a transmission quality class based on the transmission power requested with the network node, in response to the uplink transmission regulatory framework comprising the relaxed regulatory framework; wherein the transmission quality class comprises a predefined maximum power reduction; determining an output power value based on the transmission quality class, in response to the uplink transmission regulatory framework comprising the relaxed regulatory framework; determining an uplink transmission power as a minimum of: the output power value, and the transmission power requested with the network node; and transmitting an uplink transmission, based on the uplink transmission power.

Example 54: The method of example 53, further comprising: determining the output power value based on the legacy regulatory framework, in response to the uplink transmission regulatory framework comprising the legacy regulatory framework; or determining the output power value based on the legacy regulatory framework, in response to the transmission power requested with a network node being at or below a threshold; or determining the transmission quality class based on the legacy regulatory framework, in response to the uplink transmission regulatory framework comprising the legacy regulatory framework.

Example 55: The method of any of examples 53 to 54, wherein the transmission quality class is one of a number of transmission quality classes defined discretely based on a plurality of ranges of the transmission power requested with the network node.

Example 56: The method of any of examples 53 to 55, wherein the transmission quality class is defined based on an error vector magnitude limit for a modulation order.

Example 57: An apparatus includes means for determining a transmission power requested with a network node; means for quality class on determining a transmission based the transmission power requested with the network node; wherein the transmission quality class comprises a predefined maximum power reduction; means for determining an output power value based on the transmission quality class; means for determining an uplink transmission power as a minimum of: the output power value, and the transmission power requested with the network node; and means for transmitting an uplink transmission, based on the uplink transmission power.

Example 58: An apparatus includes means for requesting, with a network node, a transmission power for a user equipment; means for transmitting an uplink grant to a user equipment, the uplink grant comprising at least one parameter configured to be used to determine the transmission power requested with the network node for the user equipment; wherein a transmission quality class is determined based on the transmission power requested with the network node for the user equipment; wherein the transmission quality class comprises a predefined maximum power reduction; wherein an output power value is determined based on the transmission quality class; wherein an uplink transmission power is determined as a minimum of: the output power value, and the transmission power requested with the network node for the user equipment; and means for receiving an uplink transmission, based on the uplink transmission power.

Example 59: An apparatus includes means for receiving an uplink grant from a network node, the uplink grant comprising at least one parameter configured to be used to determine a transmission power requested with the network node; means for determining the transmission power requested with the network node, based on the at least one parameter received with the uplink grant; wherein the uplink grant comprises information related to whether an uplink transmission regulatory framework comprises a legacy regulatory framework or a relaxed regulatory framework; means for r determining a transmission quality class based on the transmission power requested with the network node, in response to the uplink transmission regulatory framework comprising the relaxed regulatory framework; wherein the transmission quality class comprises a predefined maximum power reduction; means for determining an output power value based on the transmission quality class, in response to the uplink transmission regulatory framework comprising the relaxed regulatory framework; means for determining an uplink transmission power as a minimum of: the output power value, and the transmission power requested with the network node; and means for transmitting an uplink transmission, based on the uplink transmission power.

Example 60: A non-transitory program storage device readable by a machine, tangibly embodying a program of instructions executable with the machine for performing operations, the operations comprising: determining a transmission power requested with a network node; determining a transmission quality class based on the transmission power requested with the network node; wherein the transmission quality class comprises a predefined maximum power reduction; determining an output power value based on the transmission quality class; determining an uplink transmission power as a minimum of: the output power value, and the transmission power requested with the network node; and transmitting an uplink transmission, based on the uplink transmission power.

Example 61: A non-transitory program storage device readable by a machine, tangibly embodying a program of instructions executable with the machine for performing operations, the operations comprising: requesting, with a network node, a transmission power for a user equipment; transmitting an uplink grant to a user equipment, the uplink grant comprising at least one parameter configured to be used to determine the transmission power requested with the network node for the user equipment; wherein a transmission quality class is determined based on the transmission power requested with the network node for the user equipment; wherein the transmission quality class comprises a predefined maximum power reduction; wherein an output power value is determined based on the transmission quality class; wherein an uplink transmission power is determined as a minimum of: the output power value, and the transmission power requested with the network node for the user equipment; and receiving an uplink transmission, based on the uplink transmission power.

Example 62: A non-transitory program storage device readable by a machine, tangibly embodying a program of instructions executable with the machine for performing operations, the operations comprising: receiving an uplink grant from a network node, the uplink grant comprising at least one parameter configured to be used to determine a transmission power requested with the network node; determining the transmission power requested with the network node, based on the at least one parameter received with the uplink grant; wherein the uplink grant comprises information related to whether an uplink transmission regulatory framework comprises a legacy regulatory framework or a relaxed regulatory framework; determining a transmission quality class based on the transmission power requested with the network node, in response to the uplink transmission regulatory framework comprising the relaxed regulatory framework; wherein the transmission quality class comprises a predefined maximum power reduction; determining an output power value based on the transmission quality class, in response to the uplink transmission regulatory framework comprising the relaxed regulatory framework; determining an uplink transmission power as a minimum of: the output power value, and the transmission power requested with the network node; and transmitting an uplink transmission, based on the uplink transmission power.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software firmware), as (and/or such (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash or hyphen):
3GPP third generation partnership project
4G fourth generation
5G fifth generation
5GC 5G core network
802 11 part of the IEEE 802 set of local area network (LAN) technical standards
ACLR adjacent channel leakage ratio
AI artificial intelligence
a.k.a. also known as
AMF access and mobility management function
A-MPR additional maximum power reduction
ASIC application-specific integrated circuit
AWGN additive white Gaussian noise
BER bit error ratio
BPSK binary phase-shift keying
BS base station
BWP bandwidth part
C serving cell index
C configured
CMAX configured or class maximum
CMAX_L configured or class maximum low
CMAX_H configured or class maximum high
Config configuration
CPU central processing unit
CRB common resource block
CU central unit or centralized unit
DAC digital-to-analog converter
DCI downlink control information
DFT discrete Fourier transformation
DFT-S-OFDM DFT spread OFDM
DL downlink
DMRS demodulation reference signal
DSP digital signal processor
DU distributed unit
EMAX P_{EMAX,c} is the value given by IE P-Max for serving cell c, defined in TS 38.331[7]
eNB evolved Node B (e.g., an LTE base station)
en-gNB node providing NR user plane and control plane protocol terminations towards the UE, and acting as a secondary node in EN-DC
E-UTRA evolved universal terrestrial radio access, i.e., the LTE radio access technology
EVM error vector magnitude
f carrier index
F1 interface between the CU and the DU
FDD frequency-division duplexing
FPGA field-programmable gate array
FR frequency range
gNB base station for 5G/NR, i.e., a node providing NR user plane and control plane protocol terminations towards the UE, and connected via the NG interface to the 5GC
HO handover
IAB integrated access and backhaul
IB inter-band
IBE in-band emissions
IE information element
IEEE Institute of Electrical and Electronics Engineers
I/F interface
I/O input/output
IQ in-phase and quadrature signals
LMF location management function
LMMSE linear minimum mean square error
LTE long term evolution (4G)
MAC medium access control
MAX maximum
MCS modulation coding scheme
min or MIN minimum
ML machine learning
MME mobility management entity
MPR maximum power reduction
msg3 message 3 in a 4-step RACH procedure involving scheduled UL transmission
NCE network control element
ng or NG new generation
ng-eNB new generation eNB
NG-RAN new generation radio access network
NR new radio (5G)
N/W network
OBO output power backoff
OCB occupied channel bandwidth
OFDM orthogonal frequency division multiplexing
OFDMA orthogonal frequency division multiple access
OOB out-of-band
PA power amplifier
PAPR peak-to-average power ratio
PC power class (e.g. PC3), or power control
PDA personal digital assistant
PDCP packet data convergence protocol
PHY physical layer
PHR power headroom report
Pi π, or ratio of the circumference of any circle to the diameter of that circle
PL path loss
PRACH physical random access channel
PRB physical resource block
PUCCH physical uplink control channel
PUSCH physical uplink shared channel
PSD power spectral density
QAM quadrature amplitude modulation
QOS quality of service
QPSK quadrature phase shift keying
RAM random access memory
RAN radio access network
RAN1 radio layer 1
RAN2 radio layer 2
RAN4 radio layer 4
RAN #RAN meeting
RB resource block
Rel-release
RF radio frequency
RLC radio link control
ROM read-only memory
RP-RAN meeting
RRC radio resource control (protocol)
RS reference signal
RU radio unit
Rx receiver or reception
SGW serving gateway
SI study item
SID study item description
SMF session management function
SNR signal to noise ratio
SON self-organizing/optimizing network
SRI SRS resource indicator
SRS sounding reference signal
TDD time division duplex
TF transport format
TPC transmit power control
TRP transmission and/or reception point
TS technical specification
TSG technical specification group
Tx or TX transmitter or transmission
UE user equipment (e.g., a wireless, typically mobile device)
UL uplink
UPF user plane function
V version
X2 network interface between RAN nodes and between
RAN and the core network
Xn network interface between NG-RAN nodes

1. An apparatus comprising:
at least one processor; and
at least one memory including computer program code;
wherein the at least one memory and the computer program code are configured to, with the at least one processor, cause the apparatus at least to:
determine a transmission power requested with a network node;
determine a transmission quality class based on the transmission power requested with the network node;
wherein the transmission quality class comprises a predefined maximum power reduction;
determine an output power value based on the transmission quality class;
determine an uplink transmission power as a minimum of: the output power value, and the transmission power requested with the network node; and
transmit an uplink transmission, based on the uplink transmission power.

2. The apparatus of claim 1, wherein:
the output power value is smaller than or equal to a maximum output power for a considered user equipment power class; and
the output power value is larger than or equal to: the maximum output power for the considered user equipment power class minus the predefined maximum power reduction defined for the determined transmission quality class.

3. (canceled)

4. The apparatus of claim 1, wherein the at least one memory and the computer program code are further configured to, with the at least one processor, cause the apparatus at least to:
receive an uplink grant from the network node, the uplink grant comprising at least one parameter configured to be used to determine the transmission power requested with the network node; and
determine the transmission power requested with the network node based on a transmission power formula and the at least one parameter.

5. The apparatus of claim 1, wherein the at least one memory and the computer program code are further configured to, with the at least one processor, cause the apparatus at least to:
receive an uplink grant from the network node, the uplink grant comprising information related to whether an uplink transmission regulatory framework comprises a legacy regulatory framework or a relaxed regulatory framework;
determine the transmission quality class based on the legacy regulatory framework, in response to the uplink transmission regulatory framework comprising the legacy regulatory framework, or
determine the transmission quality class based on the legacy regulatory framework, in response to the transmission power requested with the network node being at or below a threshold.

6. The apparatus of claim 1, wherein a power control range has been partitioned into at least two transmission quality classes comprising the transmission quality class, and the transmission quality class comprises at least one quality target.

7. (canceled)

8. The apparatus of claim 1, wherein the at least one memory and the computer program code are further configured to, with the at least one processor, cause the apparatus at least to:
transmit, from a user equipment to the network node, an indication indicating a capability of the user equipment to support a transmission quality class.

9. (canceled)

10. The apparatus of claim 8, wherein the transmission quality class is defined based on an error vector magnitude and a relationship such that the error vector magnitude is higher for a lower number of digital to analog bits within the transmitter.

11. The apparatus of claim 10, wherein the predefined maximum power reduction is higher for a lower number of digital to analog bits within the transmitter.

12. The apparatus of claim 1, wherein the transmission quality class is one of a number of transmission quality classes defined discretely based on a plurality of ranges of the transmission power requested with the network node.

13. The apparatus of claim 1, wherein the transmission quality class is defined based on an error vector magnitude limit for a modulation order.

14. The apparatus of claim 1, wherein the transmission quality class for a scenario comprises a more relaxed quality target for a smaller predefined maximum power reduction.

15-17. (canceled)

18. The apparatus of claim 1, wherein the transmission quality class is defined based on an allowed error vector magnitude, an allowed maximum power reduction, and/or a configured output power.

19. An apparatus comprising:
at least one processor; and
at least one memory including computer program code;
wherein the at least one memory and the computer program code are configured to, with the at least one processor, cause the apparatus at least to:
request, with a network node, a transmission power for a user equipment;
transmit an uplink grant to a user equipment, the uplink grant comprising at least one parameter configured to be used to determine the transmission power requested with the network node for the user equipment;
wherein a transmission quality class is determined based on the transmission power requested with the network node for the user equipment;
wherein the transmission quality class comprises a predefined maximum power reduction;
wherein an output power value is determined based on the transmission quality class;
wherein an uplink transmission power is determined as a minimum of: the output power value, and the transmission power requested with the network node for the user equipment; and
receive an uplink transmission, based on the uplink transmission power.

20. The apparatus of claim 19, wherein:
the uplink grant comprises information related to whether an uplink transmission regulatory framework comprises a legacy regulatory framework or a relaxed regulatory framework;
the transmission quality class is determined based on the legacy regulatory framework, in response to the uplink transmission regulatory framework comprising the legacy regulatory framework, or the transmission quality class is determined based on the legacy regulatory framework, in response to the transmission power requested with the network node for the user equipment being at or below a threshold.

21. The apparatus of claim 19, wherein a power control range has been partitioned into at least two transmission quality classes comprising the transmission quality class, and the transmission quality class comprises at least one quality target.

22. (canceled)

23. The apparatus of claim 19, wherein the at least one memory and the computer program code are further configured to, with the at least one processor, cause the apparatus at least to:
receive, with the network node from the user equipment, an indication indicating a capability of the user equipment to support a transmission quality class.

24. The apparatus of claim 19, wherein the transmission quality class is one of a number of transmission quality classes defined discretely based on a plurality of ranges of the transmission power requested with the network node for the user equipment.

25. An apparatus comprising:
at least one processor; and
at least one memory including computer program code;
wherein the at least one memory and the computer program code are configured to, with the at least one processor, cause the apparatus at least to:
receive an uplink grant from a network node, the uplink grant comprising at least one parameter configured to be used to determine a transmission power requested with the network node;
determine the transmission power requested with the network node, based on the at least one parameter received with the uplink grant;
wherein the uplink grant comprises information related to whether an uplink transmission regulatory framework comprises a legacy regulatory framework or a relaxed regulatory framework;
determine a transmission quality class based on the transmission power requested with the network node, in response to the uplink transmission regulatory framework comprising the relaxed regulatory framework;
wherein the transmission quality class comprises a predefined maximum power reduction;
determine an output power value based on the transmission quality class, in response to the uplink transmission regulatory framework comprising the relaxed regulatory framework;
determine an uplink transmission power as a minimum of: the output power value, and the transmission power requested with the network node; and
transmit an uplink transmission, based on the uplink transmission power.

26. The apparatus of claim 25, wherein the at least one memory and the computer program code are further configured to, with the at least one processor, cause the apparatus at least to:
determine the output power value based on the legacy regulatory framework, in response to the uplink transmission regulatory framework comprising the legacy regulatory framework; or
determine the output power value based on the legacy regulatory framework, in response to the transmission power requested with a network node being at or below a threshold; or
determine the transmission quality class based on the legacy regulatory framework, in response to the uplink transmission regulatory framework comprising the legacy regulatory framework.

27. The apparatus of, wherein the transmission quality class is one of a number of transmission quality classes defined discretely based on a plurality of ranges of the transmission power requested with the network node.

28-62. (canceled)
